(19) United States
(12) Patent Application Publication
(10) Pub. No.: US 2011/0134313 A1
(43) Pub. Date: Jun. 9, 2011

(54) VISUAL PRESENTER

(75) Inventor: TETSURO KATO, Aichi (JP)

(73) Assignee: Elmo Co., Ltd., Nagoya-shi (JP)

(21) Appl. No.: 12/893,491

(22) Filed: Sep. 29, 2010

(30) Foreign Application Priority Data
Dec. 3, 2009 (JP) P2009-275061

(51) Int. Cl. H04N 5/225

(52) U.S. Cl. 348/373; 348/E05.025

(57) ABSTRACT

A visual presenter includes a base, a support column mounted on the base and a video camera head mounted on a distal end of the support column. The support column includes a first support column and a second support column. The first support column is mounted on a right or left corner of a front of the base so as to be pivotable in a right-left direction relative to the base. The second support column is mounted on a distal end of the first support column so as to be pivotable in the right-left direction relative to the base. The video camera head is mounted on the distal end of the second support column so as to be pivotable in the right-left direction.

### CROSS-REFERENCE TO RELATED APPLICATIONS

This application is based upon and claims the benefit of priority from the prior Japanese Patent Application No. 2009-275061, filed on Dec. 3, 2009, the entire contents of which are incorporated herein by reference.

### BACKGROUND

1. Technical Field

The present disclosure relates to a visual presenter which includes a base, a support column mounted on the base and a video camera head mounted on a distal end of the support column and in which a material such as document, model or the like is imaged by the video camera head and an obtained image is delivered to a monitor or projected by a video projector onto a screen.

2. Related Art

Japanese Patent Application Publication JP-A-2008-193391 discloses a visual presenter of the above-described type. The visual presenter is shown in FIGS. 6 and 7 and designated by reference numeral 100. The shown visual presenter 100 includes a base 101 formed into the shape of a thick book, an inverted J-shaped support column 102 mounted on the middle of a front end of the base 101 and a cylindrical video camera head 103 mounted on a distal end of the support column 102. The distal end of the support column 102 is connected to one of two ends of the video camera head 103. An imaging lens 104 is built in the other end bottom of the video camera head 103. Several terminals are provided on the rear of the base 100 in order that the visual presenter may be connected to a monitor or the like.

The support column 102 of the above-described visual presenter 100 includes a straight portion 105 and a curved portion 106. The straight portion 105 has a proximal end which is mounted on the base so as to be rotatable (as shown by arrow A in FIG. 6) and pivotable in the front-back direction of the base 101 (as shown by arrow B in FIG. 7). Furthermore, the video camera head 103 is mounted on the distal end of the support column 102 so as to be pivotable in the right-left direction (as shown by arrow C in FIG. 6).

In order that a material may be imaged by the visual presenter 100, the material is placed on an installation surface 107 for the base 101 so as to be placed substantially beneath the imaging lens 104. On the other hand, when the visual presenter is not used, the video camera head 103 is caused to pivot in the right-left direction (in the direction of arrow C) so as to be substantially in parallel to the support column, whereupon the video camera head 103 is hung from the distal end of the support column 102. Furthermore, the support column 102 is turned (in the direction of arrow A) so that the video camera head 103 is set to be located right above the base 101. Alternatively, the support column 102 is caused to pivot forward (in the direction of arrow B) so that the video camera head 103 is grounded to the installation surface 107.

The video camera head 103 and the support column 102 remain standing on the base 101 or protrude from the base 101 even when the visual documenter 100 is not used. Accordingly, the visual presenter is inconvenient for carrying or safekeeping purpose.

### SUMMARY

Therefore, an object of the present disclosure is to provide a visual presenter which can be folded into a compact form for the convenience of the carrying and/or safekeeping purpose.

The present disclosure provides a visual presenter comprising a base having a front, a support column which is mounted on the base so as to stand and so as to be pivotable, and a video camera head mounted on a distal end of the support column, the video camera head being located substantially right above a material placed on a base installation surface so that the material is imaged by the video camera head. In the visual presenter, the support column includes a first support column and a second support column. The first support column is mounted on a right or left corner of the front of the base so as to be pivotable in a right-left direction relative to the base between a first folded position where the first support column overlaps the front of the base and a standing position where the first support column stands at a predetermined angle to the base. The second support column is mounted on a distal end of the first support column so as to be pivotable in the right-left direction relative to the base between a second folded position where the second support column overlaps the first support column and an extending position where the second support column extends from the first support column. The video camera head is mounted on the distal end of the second support column so as to be pivotable in the right-left direction between a third folded position where when the first and second support columns are located at the first and second folded positions respectively, the video camera head lies along a side of the base and an upper surface of the video camera head is substantially coplanar with an upper surface of the base and a first imaging position where when the first support column is located at the standing position and the second support column is located at the extending position, the upper surface of the video camera head is substantially parallel to the upper surface of the base.

### BRIEF DESCRIPTION OF THE DRAWINGS

In the accompanying drawings:

FIG. 1 is a perspective view of the visual presenter in accordance with one embodiment, showing a usage state thereof;

FIG. 2 is a perspective view of the visual presenter in a folded state;

FIG. 3 is a perspective view of the visual presenter

FIG. 4 is a perspective view of the visual presenter

FIG. 5 is a perspective view of the visual presenter in another usage state;

FIG. 6 is a perspective view of a conventional visual presenter; and

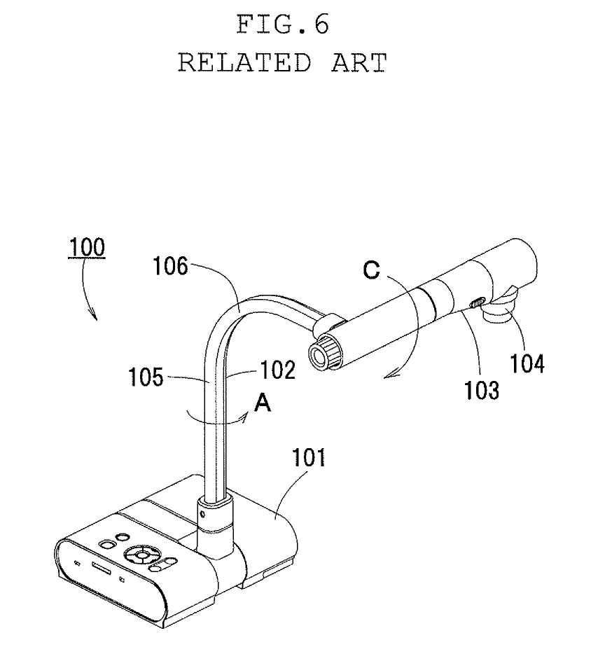

FIG. 7 is a side view of the conventional visual presenter.

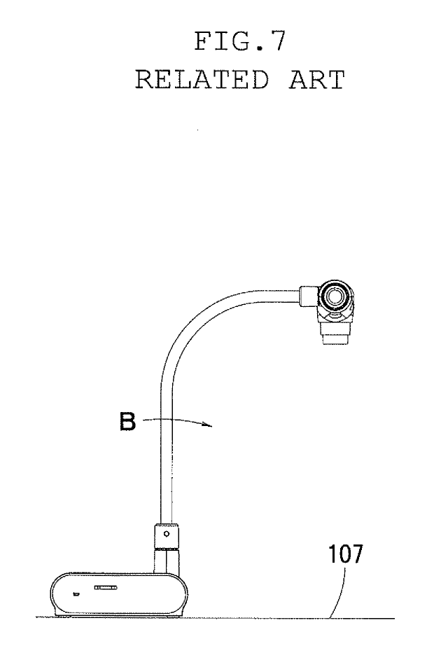

### DETAILED DESCRIPTION

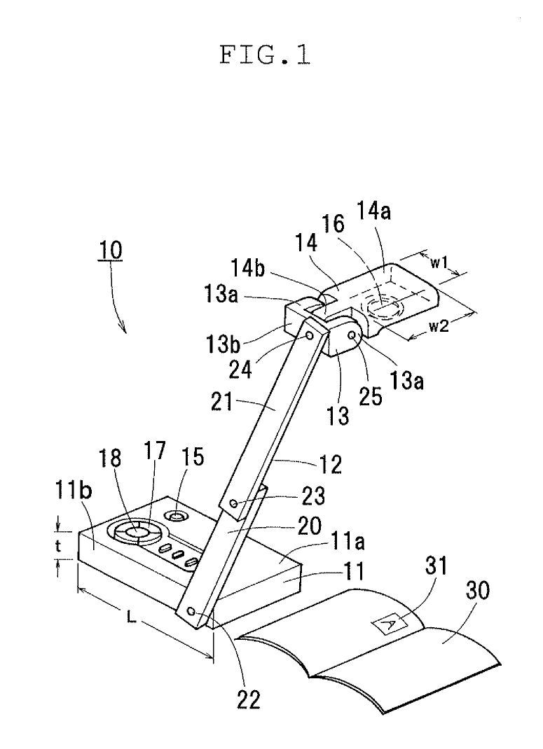

One embodiment will now be described with reference to FIGS. 1 to 5. Referring to FIG. 1, a visual presenter 10 in accordance with the embodiment is shown. The visual presenter 10 includes a base 11, a support column 12, a bracket 13 and a video camera head 14. The base 11 is formed into a box-like shape and has a substantially rectangular planar shape. More specifically, the entire base 11 has the shape of a thick book. The base 11 has an upper surface 11a on which are arranged a power switch 15, a zoom button 17 which is operated for zooming an imaging lens 16 of the video camera head 14, an autofocus button 18 for executing an autofocus control, and the like. The base 11 has a rear on which are provided several terminals 19 connecting the video presenter 10 to a monitor or a video projector. The base 11 incorporates a control circuit unit which executes a zooming control of the video camera head, an autofocusing control and a luminance control. The base 11 also incorporates weights which prevent the base 11 from being turned over by the weight of the video camera head 14.

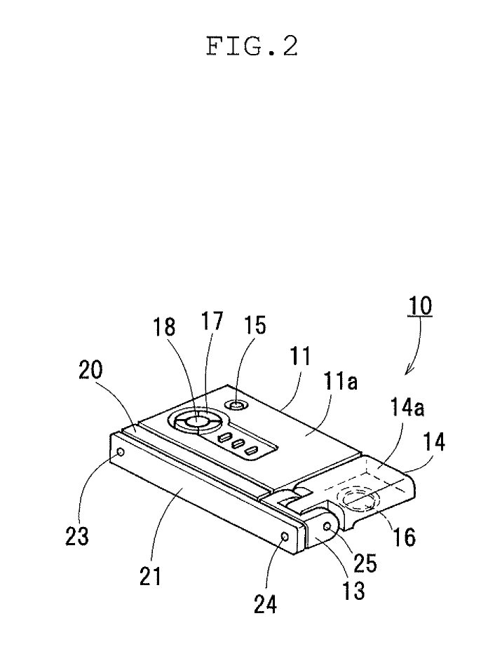

The support column 12 comprises a first support column 20 and a second support column 21 each of which has a hollow structure. Wiring is inserted through the support column 12 to connect the control circuit unit in the base 11 and the video camera head 14. The first support column 20 is formed into an elongate shape and has a width that is substantially equal to a thickness t of the base 11 and a length that is substantially equal to a horizontal width L. The first support column 20 is mounted on a first shaft 22 further mounted a right corner of the front 11b of the base 11 so that the first support column 20 is pivotable in a right-left direction relative to the base 11. The first support column 20 is pivotable in the right-left direction relative to the base 11 between a first folded position (see FIG. 2) where the first support column 20 overlaps the front 11b of the base 11 and a standing position (see FIG. 1) where the first support column 20 stands at a predetermined angle to the base 11. The aforementioned angle is set to 130 degrees to the base 11 in the embodiment.

The second support column 21 has substantially the same width as the first support column 20 and a length that is longer substantially by a horizontal with w1 of the video camera head 14 than the first support column 20. The second support column 21 is mounted on a second shaft 23 further mounted a distal end of the first support column 20 so that the second support column 21 is pivotable in the right-left direction relative to the base 11. The second support column 21 is pivotable in the right-left direction relative to the base 11 between a second folded position (see FIG. 2) where the second support column 21 overlaps the first support column 20 and an extending position (see FIG. 1) where the second support column 21 extends from the first support column 20 in the same direction as the first support column 20.

The bracket 13 includes a pair of arms 13a and a bottom 13b connecting both arms 13a, whereupon the bracket 13 has a U shape. The bottom 13b has a width which is set so as to be substantially equal to the width of the second support column 21. The bracket 13 is mounted on a third shaft 24 further mounted on the distal end of the second support column 21 so as to be pivotable in the right-left direction relative to the base 11. A length of the bottom 13b and a mounting position of the third shaft on the bottom 13b are set so that a side surface of the right arm 13a, the distal end surface of the second support column 21 and a right side surface of the video camera head 14 are substantially coplanar with one another when the bracket 13 pivots to a position where the bottom 13b overlaps the second support column 21, as shown in FIG. 2.

The video camera head 14 has a box-shaped body 14a with a rectangular planar shape. The body 14a has a projection 14b formed integrally therewith. A lens tube of the lens 16 protrudes from the bottom of the body 14a. The projection 14b is inserted between the arms 13a of the bracket 13, and a fourth shaft 25 is inserted through the projection 14b, whereby the video camera head 14 is mounted on the fourth shaft 25 further mounted on the bracket 13 so that the video camera head 14 is pivotable in a front-back direction relative to the base 11. The video camera head 14 has a horizontal width w that is set to be substantially equal to a horizontal width of the bracket 13. The video camera head 14 further has a thickness that is set so that upper surfaces of the bracket 13 and the video camera head 14 are substantially coplanar with each other. The video camera head 14 still further has a length w2 that is set so that the rears of the base 11 and the video camera head 14 are substantially coplanar with each other when the visual presenter 10 has been folded.

When a material 30 is to be imaged by the visual presenter 10 having the above-described construction, the base 11 is placed on the installation surface and connected to the monitor or projector neither shown, by a connecting cord. The first support column 20 is caused to pivot thereby to be set to the standing position as shown in FIG. 1. Furthermore, the second support column 21 is caused to pivot thereby to be set to the extending position. Still furthermore, the bracket 13 and the video camera head 14 are set to the respective positions where the upper surfaces of the bracket 13 and the video camera head 14 are substantially parallel to the upper surface 11a of the base 11. The material 30 is then placed on the base installation surface so that a part of the material 30 to be imaged is located beneath the imaging lens 16 of the video camera head 14. The zooming button 17 and the autofocusing button 18 are operated so that the material 30 is imaged.

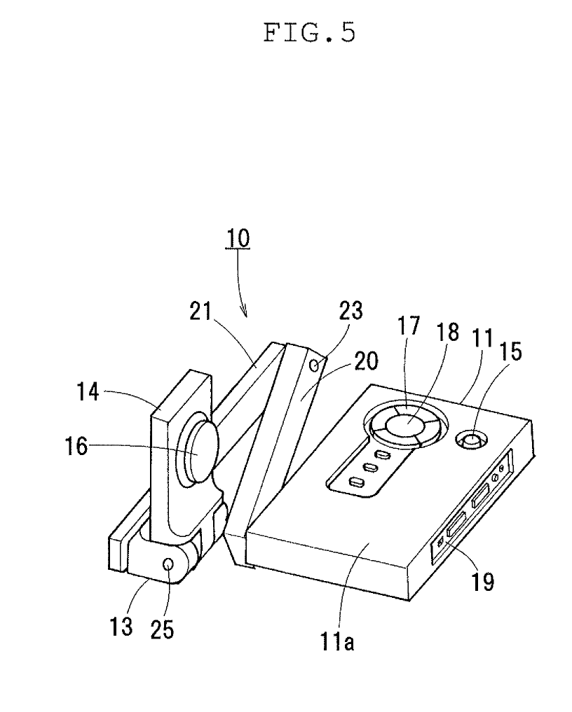

Another material placed in the rear of the base 11 can be imaged as well as the material 30 placed on the base installation surface. For example, the video camera head 14 is caused to pivot in the front-back direction relative to the base 11 so as to rise from the bracket 13, whereupon the lens tube of the imaging lens 16 can be directed rearward, as shown in FIG. 5. Thus, the video camera head 14 can be set to a second imaging position where the imaging lens 16 is directed to the rear of the base 11, and the material placed in the rear of the base 11 can also be imaged.

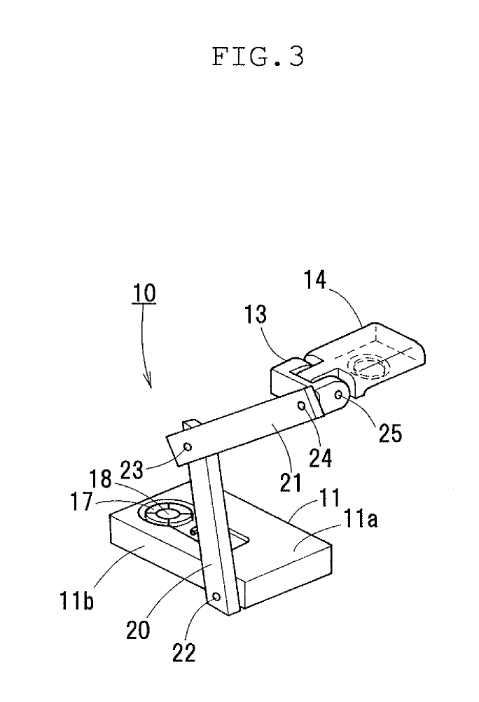

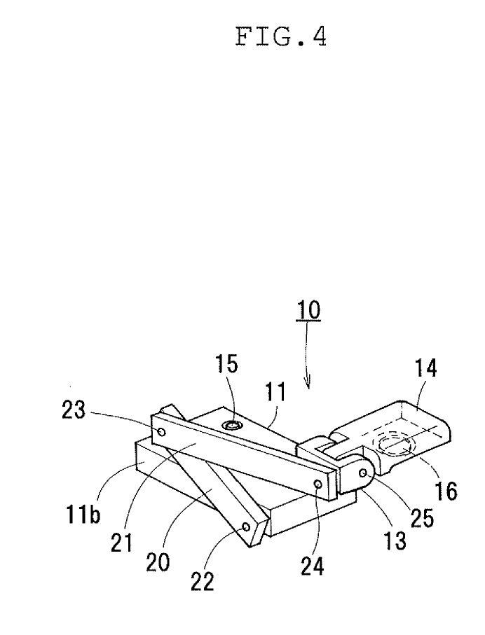

On the other hand, when the visual presenter 10 is not used, the first and second support columns 20 and 21 and the bracket 13 all in the usage state as shown in FIG. 1 are caused to pivot as shown in FIGS. 3 and 4 thereby to be folded as shown in FIG. 2. In the folded state, the first support column 20 overlaps the front 11b of the base 11, and the second support column 21 overlaps the outer surface of the first support column 20. Furthermore, the bracket 13 and the video camera head 14 are lined up along the right side of the base 11 such that the upper surfaces of the bracket 13, the video camera head 14 and the base 11 are substantially coplanar with one another. Additionally, the rear surfaces of the video camera head 14 and the base 11 are substantially coplanar with each other. Thus, the visual presenter 10 is folded into the shape of a generally thick book.

According to the above-described visual presenter 10, the first support column 20 can be folded so as to overlap the front of the base. The second support column 21 can be folded so as to overlap the first support column 20. Furthermore, the video camera head 14 can be lined up along the side of the base 11 so as to substantially parallel to the base 11. Consequently, the visual presenter 10 can be rendered more compact in the folded state and more convenient for the convenience of the carrying and/or safekeeping purpose.

The material placed on the installation surface of the base can be imaged with the video camera head 14 being set to the first imaging position. The video camera head 14 can also be set to the second imaging position to image the material placed in the rear of the base. Accordingly, the convenience of the visual presenter can further be improved.

Furthermore, the entire visual presenter 10 can be folded into the shape of a generally thick book, whereupon the visual presenter can be rendered further more convenient for the carrying and/or safekeeping purpose.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A visual presenter comprising:
a base having a front;
a support column which is mounted on the base so as to stand and so as to be pivotable; and
a video camera head mounted on a distal end of the support column, the video camera head being located substantially right above a material placed on a base installation surface so that the material is imaged by the video camera head, wherein;
the support column includes a first support column and a second support column;
the first support column is mounted on a right or left corner of the front of the base so as to be pivotable in a right-left direction relative to the base between a first folded position where the first support column overlaps the front of the base and a standing position where the first support column stands at a predetermined angle to the base;
the second support column is mounted on a distal end of the first support column so as to be pivotable in the right-left direction relative to the base between a second folded position where the second support column overlaps the first support column and an extending position where the second support column extends from the first support column; and
the video camera head is mounted on the distal end of the second support column so as to be pivotable in the right-left direction between a third folded position where when the first and second support columns are located at the first and second folded positions respectively, the video camera head lies along a side of the base and an upper surface of the video camera head is substantially coplanar with an upper surface of the base and a first imaging position where when the first support column is located at the standing position and the second support column is located at the extending position, the upper surface of the video camera head is substantially parallel to the upper surface of the base.

2. The visual presenter according to claim 1, wherein the video camera head includes an imaging lens, and the video camera head is pivotable in a front-back direction between the first imaging position and a second imaging position where the imaging lens of the video camera head is directed posterior to the base.

3. The visual presenter according to claim 1, wherein:
the base is formed into a box shape and has a rectangular planar shape;
the video camera head has substantially a rectangular planar shape;
the first and second support columns have respective widths that are substantially equal to a thickness of the base; and
the entire visual presenter is folded into a substantially book shape when the first and second support columns and the video camera head are located at the first, second and third folded positions respectively.
